(19) United States
(12) Patent Application Publication
(10) Pub. No.: US 2017/0038628 A1
(43) Pub. Date: Feb. 9, 2017

(54) LIQUID CRYSTAL ARTICLE AND FABRICATION THEREOF

(71) Applicant: LIGHT POLYMERS HOLDING, Grand Cayman (KY)

(72) Inventors: Akihiro MOCNIZUKI, Louisville, CO (US); Evgeny MOROZOV, Burlingame, CA (US); Valeriy KUZMIN, San Bruno, CA (US)

(21) Appl. No.: 15/305,275

(22) PCT Filed: Apr. 23, 2015
(86) PCT No.: PCT/IB2015/001101

§ 371 Date: Oct. 19, 2016

Related U.S. Application Data
(60) Provisional application No. 61/982,902, filed on Apr. 23, 2014.
(60) Provisional application No. 62/008,855, filed on Jun. 6, 2014.
(60) Provisional application No. 62/018,141, filed on Jun. 27, 2014.

(51) Int. Cl. G02F 1/1337; G02F 1/137; C09K 19/56

(52) U.S. Cl. CPC G02F 1/13378; C09K 19/56; G02F 1/137; G02F 1/133711; G02F 2001/133302

(57) ABSTRACT

Provided are liquid crystal articles and methods for forming the same. The liquid crystal articles comprise a substrate and an alignment layer deposited over the substrate. The alignment layer includes a molecular crystalline material formed from a lyotropic liquid crystal material. The liquid crystal device includes a thermotropic liquid crystal layer deposited over the alignment layer.

### RELATED APPLICATIONS

This application claims the benefit of U.S. Provisional Application Ser. No. 61/982,902, filed Apr. 23, 2014, and U.S. Provisional Application Ser. No. 62/008,855, filed Jun. 6, 2014, and U.S. Provisional Application Ser. No. 62/018,141, filed Jun. 27, 2014, which are incorporated herein by reference in their entirety.

### FIELD

This disclosure relates generally to optical components including thermotropic liquid crystals, alignment of the thermotropic liquid crystals on a surface of a substrate, and more particularly, to an alignment layer that includes a molecular crystalline material formed from a lyotropic liquid crystal material.

### BACKGROUND

Thermotropic liquid crystals are widely used as a part of optical components, for example, in liquid crystal display (LCD) technology. They find their use as electro-optically active materials, as well as liquid crystal-based optical compensation plates in a variety of applications, such as cell phones, computers, large flat panel TVs, etc. There is a constant market demand for competitive improvement of display performance—either dynamic characteristics like switching times, or viewing angles and contrast ratios. Beyond that, liquid crystal devices are also used for non-display applications, such as sensors, light amplitude and phase modulation devices, infrared modulation devices, smart architectural windows, and so forth. These non-display applications are mostly in emerging markets and also require better performance, especially faster optical response.

Regardless of the specific applications of liquid crystal devices, manufacturers are concerned about production costs. The production cost of liquid crystal devices is governed by manufacturing processes and materials used at each process step. In particular, LCDs have a high manufacturing cost relative to sale price. If the liquid crystal device performs well in a certain application, the pressure for cost reduction of the liquid crystal device is relatively low; however, if the performance in a specific application is limited, the pressure for cost reduction becomes high.

Among the variety of functionalities, optical response time is important in liquid crystal devices. Therefore, if significant improvement in optical response time can be achieved with no change or even decrease in manufacturing costs, then the liquid crystal device can be adopted in the marketplace.

A similar statement is valid with respect to the angular dependence of contrast ratios of LCDs. If the compensation set within the LCD panel can be realized more cost efficiently then the liquid crystal device becomes more competitive.

For example, cell phone screens, especially smartphone screens, require very bright screen luminance, high contrast, but low power consumption. When cell phones are used in bright ambient light environments, such as on a sunny day outdoors, screen images are difficult to read due to the bright ambient light. Smartphone screen luminance is usually set brighter than that of computer screen luminance. Furthermore, due to significant developments in data transmission over ultra-high frequency (UHF) bands, cell phones need to have a data processing capability almost equivalent to that of laptop computers. The cell phone screens are also expected to have full motion video image capability with bright screen luminance.

In order to have an optical response fast enough for full motion video of satisfactory image quality, several types of liquid crystal drive modes have been developed and are used for the aforementioned applications. The liquid crystal drive modes can support full motion video images either on large size screen TVs or on small size, but high-resolution smartphone screens. However, due to the demand for extremely high resolution for the smartphone screen and given that thin film transistor (TFT) size remains nearly the same, the aperture ratios in smartphone screens are significantly compromised. Table 1 compares typical aperture ratio of display screens for 55-inch full HD (1920×1080 pixels) and 5-inch full HD (1920×1080 pixels) formats.

TABLE 1
Comparison of aperture ratios of 55-inch and 5-inch screens

| | 55-inch diagonal screen | 5-inch diagonal screen |
|---|---|---|
| Pixel pitch (μm) | 220 × 660 | 20 × 60 |
| Aperture ratio (%) | 88.15 | 41.67 |

Table 1 shows that a smartphone screen has a significantly lower aperture ratio in spite of a need for low battery consumption. In a rough comparison, if the aperture ratio of a smartphone screen is a little less than half of that of a large TV screen, with a requirement for 4 times greater screen luminance, the smartphone screen would consume over 8 times greater power per unit area than a TV screen. This order-of-magnitude greater power requirement on unit area basis, compared to large TVs, places stringent demands on battery-driven equipment. Moreover, the aperture ratio comparison in Table 1 is based only on physical dimension factors. Current major LCD technologies use both in large TVs and smartphones also limit light transmission due to their complicated sub-pixel structures. Actual aperture ratios in the most advanced LCD drive modes are roughly 70% in a 55-inch diagonal screen and 30% in a 5-inch diagonal screen. The primary factor contributing to this significant reduction of aperture ratio for a smaller sized screen is the smaller pixel size, regardless of the LCD panel design. In addition to the smaller pixel size, the liquid crystal drive mode is a secondary factor in reducing the aperture ratio. The LCD industry needs to adopt liquid crystal driving modes with fast enough optical response time to enable satisfactory full motion video image quality, even if that entails sacrificing aperture ratio which results in significant reduction of light efficiency and concurrent reduction of power efficiency.

The flat panel display industry has been choosing lower light efficiency LCD drive modes which sacrifice power efficiency in order to achieve sufficiently fast optical response that enables sufficiently crisp full motion image quality. Under these conditions demand for higher contrast ratios becomes even more significant.

The need for fast response also relates to phase modulation devices. Unlike optical amplitude modulation devices like LCD devices, phase modulation devices have some complicated liquid crystal electrode structures. Regardless of the electrode structures, sufficiently fast phase modulation performance creates more opportunities for liquid crystal based phase modulation devices.

The current major LCDs such as Twisted Nematic (TN) LCDs, In-Plane Switching (IPS) LCDs, and Fringe Field Switching (FFS) LCDs, require a mechanical rubbing process for liquid crystal molecular alignment. Unlike most other LCD manufacturing processes, the mechanical rubbing process is a physical contacting and rubbing process that creates both electrostatic charges and tiny dust. Electrostatic charges are one of the major factors responsible for damage to thin film transistors (TFTs). Tiny dust causes uneven panel gaps in liquid crystal panels. Moreover, for both IPS LCDs and FFS LCDs, flexoelectric effects are the factors contributing to deterioration of display image quality. The current commercially available rubbing cloth has a single pile diameter much larger than the size of a liquid crystal molecule. Therefore the mechanical rubbing affects the top surface of the liquid crystal alignment layer on a length scale much larger than the size of a liquid crystal molecule. Since flexoelectric driving torque is linear to the applied electric field, unlike dielectric driving torque, flexoelectric driving torque is more sensitive than dielectric driving torque. Therefore, for both IPS LCDs and FFS LCDs, a much finer size liquid crystal molecular anchoring effect is required to suppress flexoelectric driving torque.

Current liquid crystal devices consist of stacks of different types of dielectric layers, such as liquid crystal molecular alignment layers, liquid crystal layers, passivation layers, and so forth. The externally applied electric field is divided among these dielectric layers depending on their dielectric properties; and the effective voltage over the liquid crystal layer is a fraction of the externally applied voltage. Therefore, adjusting the permittivities of some of the dielectric layers is one of the ways to improve the optical response time of liquid crystal devices. Current commercially available liquid crystal molecular alignment layer materials are polyimide, polyamide, polyimide-amide, polyvinyl alcohol and so forth. Permittivities of such materials are no more than 4, and permittivities of most of liquid crystal materials are over 10. This difference in permittivities reduces the effective electric field strength over the liquid crystal layer, resulting in a slower rise time. In order to achieve faster rise times, it would be desirable to increase the permittivities of liquid crystal alignment layer materials to be closer to the permittivities of liquid crystal materials.

The need for wide viewing angles and high contrast ratios on the panel level has also been a reason to sacrifice power efficiency. Thanks to significant improvements in the so-called optical compensation methods, in which an optical compensation film is placed outside the liquid crystal panels, wide viewing angles are now available with “external” optical compensation means outside of liquid crystal panels.

Current LCDs incorporate various types of birefringent films in order to compensate for the natural birefringence of the liquid crystal layer in the LC cell. These films possess birefringent properties complementary to the birefringent properties of the LC layer.

Conventional uniaxial or biaxial compensation films are usually prepared through uniaxial or biaxial stretching of polymer films. However the stretching puts limitations on the waveplate types that can be realized. At the same time the most natural way to compensate for the birefringence of the liquid crystal is to use other liquid crystal molecules and polymers.

Coatable compensation layers are deposited from liquid crystal materials in such a way the after solidifying the resultant molecular alignment realizes the required type of birefringence. Molecular arrangement in the thermotropic liquid crystals depends on the boundary conditions—the properties of the surfaces it is in contact with and their parameters like surface energy and surface morphology. Manipulating with the parameters one can realize conventional waveplates or more complex compensation properties.

There are products on the market utilizing this approach. For example the Fuji Wide View Angle film (negatively birefringent films with a tilted optical axis) comprises thermotropic liquid crystal layer and its production includes steps such as deposition of an alignment layer and mechanical rubbing in order to attain a specific molecular arrangement of the thermotropic liquid crystal ensuring the required functionality.

Thus, it would be desirable to provide the alignment layer capable of orienting the thermotropic liquid crystal on molecular scale. It would enable liquid crystal devices to have faster electro-optical response, higher contrast ratios, lower threshold voltages, and improved display quality, as well as liquid crystal device manufacturing methods free of mechanical rubbing.

### SUMMARY

Provided are liquid crystal optical components and methods for forming the same. The liquid crystal optical component comprises a substrate and an alignment layer deposited over the substrate. The alignment layer includes a molecular crystalline material formed from a lyotropic liquid crystal material. The liquid crystal optical component includes a thermotropic liquid crystal layer deposited over the alignment layer.

The present disclosure describes a ‘molecular crystalline alignment layer’. This molecular crystalline layer can be characterized as comprising a long-range uniaxially aligned, self-repeating structure, wherein the size of the repeating unit is comparable to the size of the thermotropic liquid crystal molecules.

According to one aspect of the present disclosure, provided is a liquid crystal article. The liquid crystal article comprises a first substrate and second substrate and an alignment layer on the first substrate. The alignment layer is formed of a molecular crystalline material comprising lyotropic liquid crystal materials. The liquid crystal article can include a thermotropic liquid crystal layer disposed between the first substrate and second substrate. The thermotropic liquid crystal layer comprises material selected from but not limited to nematic and smectic thermotropic liquid crystal materials.

According to another aspect of the present disclosure, a liquid crystal article is provided. The liquid crystal article comprises a substrate and an alignment layer deposited on the substrate. The alignment layer comprises a molecular crystalline material that is formed from a lyotropic liquid crystal material. The liquid crystal article optionally includes a primer layer that provides adhesion between the alignment layer and the substrate. The liquid crystal article further comprises a thermotropic liquid crystal layer deposited over the alignment layer.

According to yet another aspect of the present disclosure, a liquid crystal article comprises a substrate and an alignment layer deposited over the substrate. The alignment layer comprises a molecular crystalline material that is formed from a lyotropic liquid crystal material, wherein the molecular crystalline material is arranged on the surface of the substrate to form isolated discrete structures. These isolated discrete structures are collectively referred to as the alignment layer. The liquid crystal article further comprises a thermotropic liquid crystal layer deposited over the alignment layer.

According to one more aspect of the present disclosure, a method for forming a liquid crystal article is described. According to the method, a substrate is provided and an alignment layer is deposited over the substrate. The alignment layer is formed by shear coating lyotropic liquid crystal material onto the substrate. After deposition of the alignment layer, a thermotropic liquid crystal layer can be deposited over the alignment layer and the alignment layer is capable of aligning the thermotropic liquid crystal layer.

These and various other features and advantages will be apparent from a reading of the following detailed description.

### BRIEF DESCRIPTION OF THE DRAWINGS

Embodiments are illustrated by way of example, and not by limitation in the figures of the accompanying drawings, in which like references indicate similar elements and in which:

FIG. 1. shows a schematic cross-sectional diagram of an illustrative liquid crystal panel, according to an example embodiment;

FIG. 2 shows voltage distribution across different dielectric layers in an illustrative liquid crystal panel, according to an example embodiment;

FIG. 3A is a schematic diagram illustration of planar liquid crystal molecular anchoring on an alignment layer on a substrate, according to an illustrative embodiment;

FIG. 3B is a schematic diagram illustration of homeotropic liquid crystal molecular anchoring on an alignment layer on a substrate, according to an illustrative embodiment;

FIG. 4 is a schematic diagram illustration of planar liquid crystal molecular anchoring on a on an alignment layer on a substrate that includes a primer layer, according to an illustrative embodiment;

FIG. 5 is a schematic diagram illustration of homeotropic liquid crystal molecular anchoring on a an alignment layer on a substrate that includes a primer layer, according to an illustrative embodiment;

FIG. 6A is a schematic diagram illustration of a surface anchoring interaction according to a conventional solution;

FIG. 6B is a schematic diagram illustration of a surface anchoring interaction according to an illustrative embodiment;

FIG. 7 is a schematic diagram partial cross-sectional view of a molecular alignment layer according to an illustrative embodiment;

FIG. 8 is a schematic diagram top view of the molecular alignment layer of FIG. 7;

FIG. 9 is a schematic partial cross-sectional view of an exemplary thin film transistor (TFT) substrate in a liquid crystal device;

FIG. 10A shows a schematic diagram perspective exploded view of a sample panel for a permittivity measurement;

FIG. 10B shows a schematic diagram cross-sectional view of a sample panel for a permittivity measurement;

FIG. 11 shows schematic diagram cross-sectional view of a permittivity measurement experimental set-up;

FIG. 12 shows a schematic diagram perspective exploded view of a sample panel for a twisted nematic liquid crystal panel, according to an example embodiment;

FIG. 13 shows schematic diagram of an electro-optical measurement set-up, according to an example embodiment;

FIGS. 14A-14D show threshold voltages of liquid crystal panels according to example embodiments, and of a control liquid crystal panel;

FIGS. 15A-15D show the rise time of liquid crystal panels according to example embodiments, and of a control liquid crystal panel;

FIG. 16 is a graph illustrating a relationship between surface pre-tilt angle and flexo printer print pressure, for liquid crystal devices according to an illustrative embodiment;

FIGS. 17A-17C show the electro-optical response of liquid crystal panels according to example embodiments; and

FIG. 18 shows the rise and fall times of smectic liquid crystal panels according to example embodiments.

### DETAILED DESCRIPTION

In the following description, reference is made to the accompanying figures that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising,” and the like.

The term “molecular crystalline” refer to a layer comprising a long-range uniaxially aligned, self-repeating structure, wherein the size of the repeating unit is comparable with the size of the liquid crystal molecules.

The term “shear coating” includes coating a material with shear force applied to the coating material, such as, printing, blade coating, microgravure, slit-die coating, slot-die coating, curtain coating, and the like, for example. The term “printing” includes ink jet printing, flexoprinting, screen printing, and the like.

The present disclosure relates to a molecular crystalline alignment layer deposited from a material in which molecules are capable of self-assembling into regular aggregates, the aggregates being aligned substantially in the same direction upon deposition and being comparable in size to thermotropic liquid crystal molecules found in the liquid crystal layer of the liquid crystal panel. Such material possessing translational symmetry in one or more directions is additionally called crystalline material. Periodic molecular arrangement creates directional electron surface density patterns on the molecular scale, which guides the anchoring of thermotropic liquid crystal molecules. In such a way the periodic structure of the alignment layer leads to thermotropic liquid crystal alignment, eliminating the necessity for mechanical rubbing step or an optical exposure step. In many embodiments the alignment layer is formed of lyotropic liquid crystal material. While the present disclosure is not so limited, an appreciation of various aspects of the disclosure will be gained through a discussion of the examples provided below.

The present disclosure gives both theoretical and experimental considerations to the problem. The theoretical portion consists of analysis of the voltage distribution in a liquid crystal device, which helps to specify requirements for an alignment layer. The experimental portion focuses on various aspects of practical implementation of the theory.

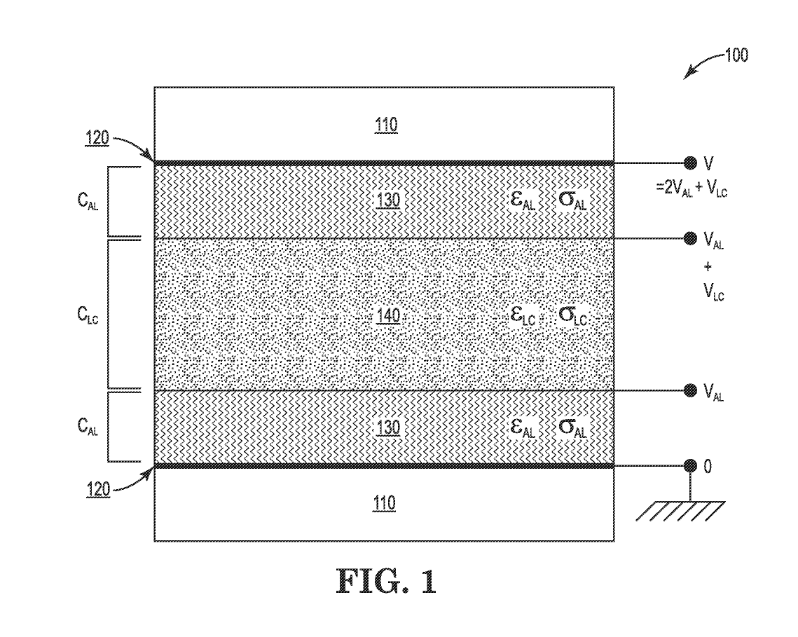

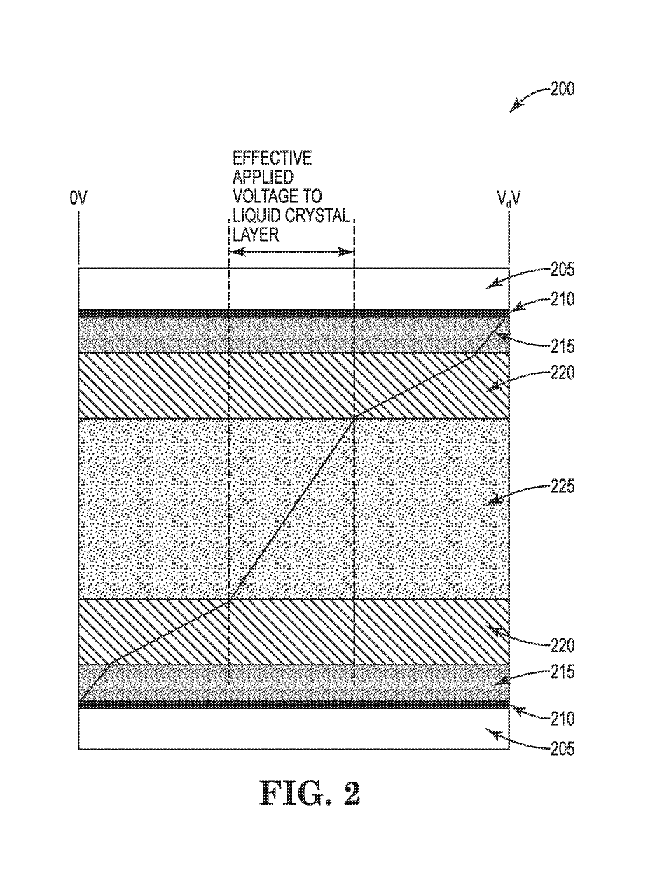

Cross-sectional structure a typical liquid crystal device is given in FIG. 1. Corresponding voltage distribution throughout the device is presented in FIG. 2. Equations 1 and 2 below describe a liquid crystal panel 100 including two dielectric substrates 110, a liquid crystal layer 140, molecular alignment layers (also called alignment layers) 130, and electrodes 120. The molecular alignment layers 130 and electrodes 120 are disposed on the substrates 110 facing toward each other, and the liquid crystal layer is disposed between the substrates 110.

$$\begin{matrix}\frac{1}{{C}_{TOTAL}} = \frac{1}{{C}_{AL}} + \frac{1}{{C}_{LC}} + \frac{1}{{C}_{AL}} = \frac{2 {C}_{LC} + {C}_{AL}}{{C}_{LC} \cdot {C}_{AL}} & ( Equation 1 ) \\ V = {V}_{AL} + {V}_{LC} + {V}_{AL} = \frac{{Q}_{LC}}{{C}_{LC}} + \frac{2 {Q}_{AL}}{{C}_{AL}} & ( Equation 2 )\end{matrix}$$

In Equations 1 and 2, C_{TOTAL}, C_{AL}, and C_{LC} represent total capacitance of the dielectric layer stack in the panel 100, capacitance of each of the alignment layers 130, and capacitance of the liquid crystal layer 140, respectively. V, V_{AL}, and V_{LC} represent total applied voltage to the panel 100 externally, applied voltage on the alignment layer 130 only, and applied voltage on the liquid crystal layer 140 only, respectively. Q_{LC} and Q_{AL} represent stored charge at the liquid crystal layer 140 and the alignment layer 130, respectively.

FIG. 2 illustrates voltage distribution in a liquid crystal panel 200 that includes glass substrates 205, transparent electrodes 210, passivation layers 215, alignment layers 220, and a liquid crystal layer 225. The externally applied voltage V_{d} is divided among the layers depending on the permittivity of each layer, as shown in FIG. 2. As shown in FIG. 2, a portion of the externally applied voltage V_{d} is applied across the liquid crystal layer 225. From Equations 1 and 2, and FIGS. 1 and 2, it can be seen that the total externally applied voltage is divided among the alignment layers 220, passivation layers 215, and the liquid crystal layer 225. When the voltages applied across the alignment layers 220 and the passivation layers 215 are high compared to that of the liquid crystal layer 225, the effective applied voltage on the liquid crystal layer 225 is correspondingly reduced. Typical response times of the liquid crystal device 200 are expressed as follows in Equations 3 and 4.

$$\begin{matrix}{τ}_{ON} = \frac{{γ}_{1}}{{ɛ}_{0} Δɛ ( {E}^{2} - {E}_{C}^{2} )} & ( Equation 3 ) \\ {τ}_{OFF} = \frac{{γ}_{1} {d}^{2}}{{π}^{2} K} , & ( Equation 4 )\end{matrix}$$

where τ_{ON} and τ_{OFF} are the electro-optical response time for electric field application and electric field removal, respectively, γ₁ is the rotational viscosity of the liquid crystal material, ∈₀ is the dielectric constant of vacuum, Δ∈ is the anisotropy of the dielectric constant of liquid crystal material, E is the electric field strength in the liquid crystal layer, E_{C} is the threshold electric field strength of the liquid crystal material, d is the liquid crystal layer thickness, and K is the elastic modulus of liquid crystal layer.

Equation 3 represents rise time or “on time,” and Equation 4 represents fall time or “off time.” Equation 3 shows that the rise time is strongly dependent on applied electric field strength, and Equation 4 shows that fall time is strongly dependent on both the liquid crystal layer thickness and the elastic modulus of the liquid crystal material. Although not explicitly mentioned in Equations 3 and 4, a liquid crystal panel that contains a stack of different dielectric materials, such as a liquid crystal layer, passivation layers, and alignment layers, requires consideration of a dynamic effective electric field strength. Due to a time delay between application of an external electric field and development of an actual electric field at each dielectric layer of the stack, the electro-optic response of the liquid crystal layer is governed by a dynamic effective electric field strength that sometimes is crucial in determining the actual response time.

Since the liquid crystal materials used in the most liquid crystal devices have relatively large permittivities in the range of 10-50, the alignment layer is expected to have its permittivity at least on the same level in order to reduce the voltage loss and reduce the threshold voltage of the liquid crystal device. Lower threshold voltage opens a way to lower power consumption.

Thermotropic liquid crystals used as an active layer in LCDs need certain boundary conditions to achieve uniform alignment, in other words the alignment of thermotropic liquid crystal molecules is not a self-sustaining effect. Conventionally, liquid crystal molecular alignment on certain surfaces has been primarily interpreted in terms of steric interactions between the topmost anchoring surface and the liquid crystal molecules. The specific boundary conditions are conventionally realized by rubbing of the alignment layer.

Characteristic length scale of surface modification by the mechanical rubbing is defined by the pile diameter of the rubbing cloth, which is about 20 μm. However, the correlation distance of thermotropic (i.e., nematic or smectic) liquid crystal molecular phases is several tens of liquid crystal molecules, which add up to about 100 nm. Therefore, in order to have uniform bulk liquid crystal molecular alignment in a liquid crystal panel for high electro-optical performance, it is desirable to realize surface anchoring with increments of 100 nm or less, as described in detail below.

In one embodiment, in order to implement periodic modulation of the alignment layer surface properties, thereby enabling favorable conditions for alignment of the thermotropic liquid crystal molecules, it is suggested to use an organic molecular crystalline alignment layer. This molecular crystalline alignment layer is seen to have a uniaxially aligned self-repeating structure, in which the size of the repeating unit is comparable in size to the thermotropic liquid crystal molecules. Since under these conditions most of the molecules of the thermotropic liquid crystal molecules at the interface with the alignment layer would be under the action of an aligning force, the electro-optic response can be effectively improved even in extremely fine pitch liquid crystal displays with IPS and FFS in accordance with the present disclosure. Such a molecular crystalline alignment layer then does not require any mechanical rubbing.

In another embodiment, the molecular crystalline layer as described above is obtained with the use of materials demonstrating a liquid crystalline phase, preferably lyotropic liquid crystalline phase, under certain conditions. Some types of liquid crystal molecules, such as discotic liquid crystal molecules, and rod-shaped liquid crystal molecules tend to form self-repeating structures, and usually possessing extended electron conjugation system show large permittivity.

A liquid crystalline material is called lyotropic′ if phases having long-ranged orientational order are induced by the addition of a solvent, such as water. Historically this term is used to refer to materials composed of amphiphilic molecules. Such molecules include a hydrophilic moiety (which may be ionic or non-ionic) attached to a hydrophobic moiety (polyaromatic structures or saturated/unsaturated hydrocarbon chains).

Amphiphilic molecules form aggregates through a self-assembly process that is driven by the hydrophilic-hydrophobic interactions when they are mixed with a solvent. The aggregates formed by amphiphilic molecules in water are characterized by structures in which the hydrophilic part shields its hydrophobic counterpart from contact with water. For most lyotropic systems aggregation occurs only when the concentration of the amphiphile exceeds a critical concentration (known variously as the ‘critical micelle concentration’ (CMC) or the ‘critical aggregation concentration (CAC)’).

At the process step of alignment layer formation, the lyotropic liquid crystal material contains a solvent such as water. After the appropriate alignment layer structure is formed, the layer should be converted to solid state by drying.

Materials that Form Lyotropic Liquid Crystals

The materials that form lyotropic liquid crystals can be made from various base materials having suitable optical and other properties, such as thermal stability, light transmittance, and the like. Of particular interest are lyotropic liquid crystal materials are water-soluble and exhibit a liquid crystal phase in water. These lyotropic liquid crystals can be deposited, or coated (preferably shear coated) onto a substrate via an aqueous solution. Once coated, the aligned lyotropic liquid crystals can be stabilized or made less water-soluble by cross-linking or by ion exchange, generally termed “passivation.”

The molecular alignment layer can be formed of one or more of the following structures or polymers:

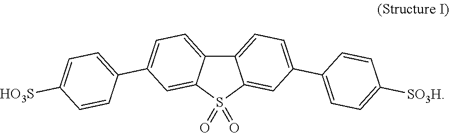 [SMILES: O=S(=O)(O)c1ccc(-c2ccc3c(c2)S(=O)(=O)c2cc(-c4ccc(S(=O)(=O)O)cc4)ccc2-3)cc1]

Structure I is: 4,4′-(5,5-dioxidodibenzo[b,d]thiene-3,7-diyl)dibenzenesulfonic acid, and is described in US 2010/0215954, incorporated by reference herein.

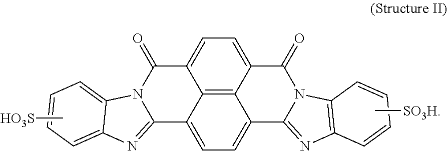

Structure II is: cis-naphthoylenebis(sulfo-benzimidazole), and is described in US 2009/0268136, incorporated by reference herein.

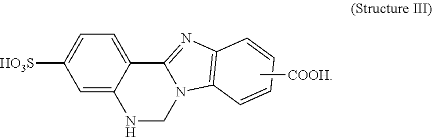

Structure III is: 2(3)-sulfo-6,7-dihydrobenzimidazo[1,2-c]quinazoline-6-one-9(10)-carboxylic acid, and is described in US 2010/0039705, incorporated by reference herein.

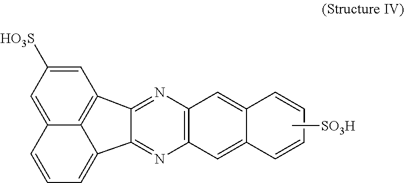

Structure IV is: acenaphtho[1,2-b]benzo[9]quinoxaline disulfonic acid, and is described in U.S. Pat. No. 8,512,824, incorporated by reference herein.

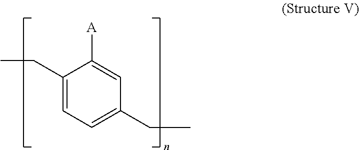

Structure V represents a polymer where A is selected from SO₃H or COOH and n is an integer from 5 to 10,000, preferably 20 to 50. Structure V where A=SO₃H is referred to as poly(sulfo-p-xylene) and is described in US 2012/0113380, incorporated by reference herein.

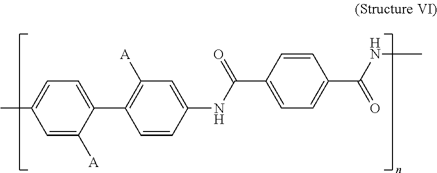

Structure VI represents a polymer where A is selected from SO₃H or COOH and n is an integer from 5 to 10,000, preferably 50 to 3000. Structure VI where A=SO₃H is referred to as poly(2,2′-disulfo-4,4′-benzidine terephthalamide) and is described in U.S. Pat. No. 8,512,824, incorporated by reference herein.

These structures or polymers can be a salt of an alkali metal, ammonium, quaternary ammonium, alkali earth metal, Al³⁺, La³⁺, Fe³⁺, Cr³⁺, Mn²⁺, Cu²⁺, Zn²⁺, Pb²⁺, Sr²⁺ or Sn²⁺. These structures or polymers can be in the form of their free acid.

### Pre-Tilt Angle

In yet another embodiment, the liquid crystal surface pre-tilt angle is controlled by adjusting the molecular packing density of the alignment crystalline material layer. The surface packing density up to 100 nm length scale is mainly controlled by the thickness of the alignment layer. In general, a thinner molecular crystalline material layer has a greater packing density of molecular crystalline layer. To provide sufficient surface coverage on surface topography of TFT arrays and color filter arrays, the thickness of the alignment layer is configured to be at least 30 nm.

The concept of surface liquid crystal molecular alignment is a function of surface energy comparison between the surface and liquid crystal molecules. Thermotropic nematic liquid crystal molecules are anchored on the surface of the alignment layer. Most of the thermotropic nematic liquid crystal materials have surface energies in the range of 26-30 dyn/cm. When surface energy of the alignment layer is smaller than that of liquid crystal molecules (less than 25 dyn/cm), the liquid crystal molecules are anchored homeotropically. When surface energy of the alignment layer is larger than that of liquid crystal molecules (more than 35 dyn/cm), the liquid crystal molecules are anchored as planar.

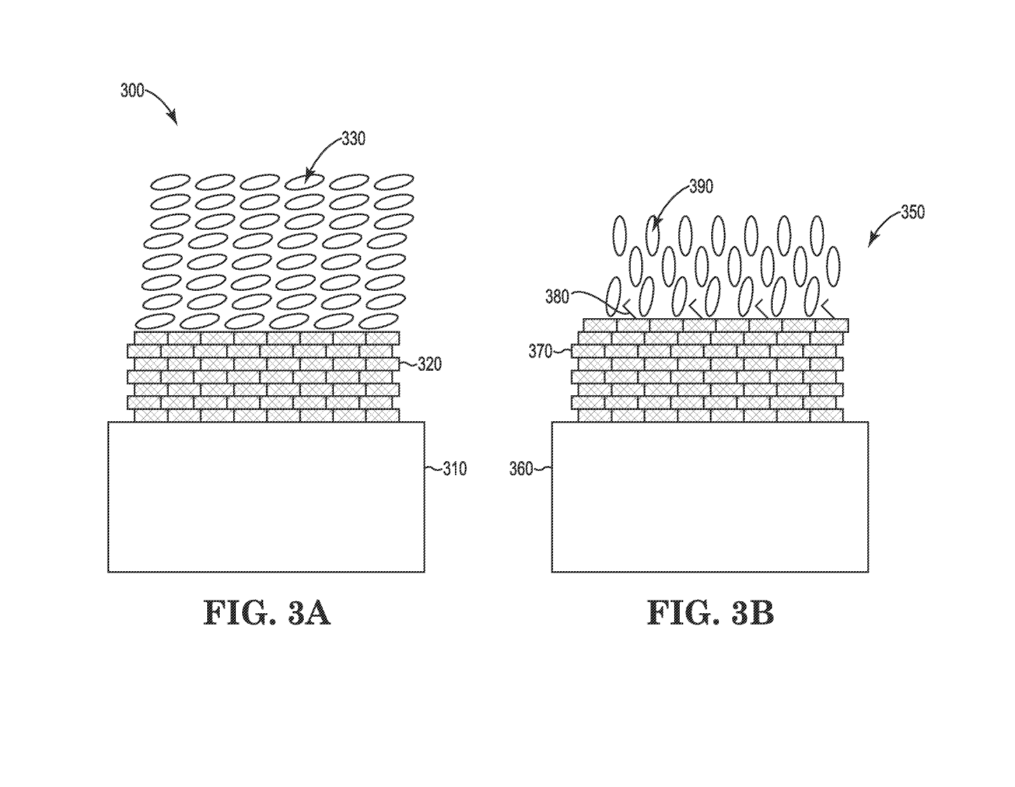

A practical way to control over the liquid crystal anchoring is to have surface modification of the top surface of the alignment layer. FIG. 3A is a partial view of an example embodiment of a liquid crystal device 300 and FIG. 3B is a partial view of an example embodiment of a liquid crystal device 350, illustrating planar and homeotropic liquid crystal molecular alignment, respectively. The liquid crystal device 300 comprises a substrate 310. An alignment layer 320 is deposited over the substrate 310. The alignment layer 320 includes molecular crystalline material formed from a lyotropic liquid crystal material. The uniaxial molecular alignment structure has permittivity of 10 to 100 (preferably from 20 to 80, and more preferably from 30 to 50). The alignment layer has a thickness of 30 to 100 nanometers, preferably 50 to 80 nanometers.

The alignment layer 320 is formed from a lyotropic liquid crystal material. The lyotropic liquid crystal material is in a nematic liquid crystal phase at temperatures of 20° C. to 25° C. The liquid crystal device 300 further comprises a liquid crystal layer 330 deposited over the alignment layer 320. The liquid crystal layer 330 is preferably a thermotropic liquid crystal layer.

The liquid crystal device 350 comprises a substrate 360. An alignment layer 370 is deposited over the substrate 360. The alignment layer 370 includes molecular crystalline material formed from a lyotropic liquid crystal material. A top surface of the alignment layer 370 is modified with a surface modification agent or surfactant 380 (such as stearic acid and/or similar type of silane coupling agents) to make the top surface hydrophobic and decrease surface energy of the top surface of the alignment layer 370, resulting in a surface energy that is lower than a surface energy of the thermotropic liquid crystal material and inducing homeotropic alignment of the thermotropic liquid crystal molecules. The liquid crystal device 350 further comprises a liquid crystal layer 390 deposited over the surface modification agent or surfactant 380.

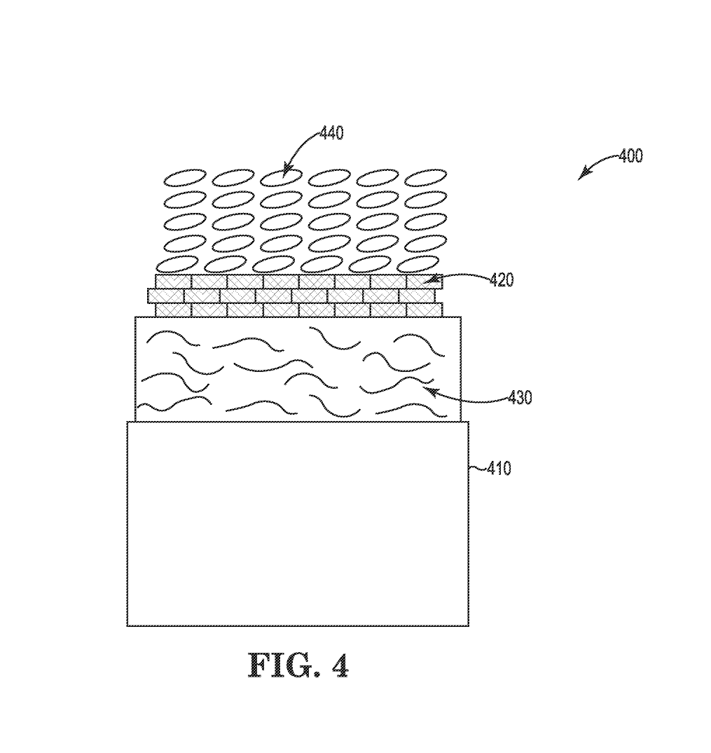

FIG. 4 is a partial view of a liquid crystal device 400, according to an example embodiment. The liquid crystal device 400 comprises a substrate 410. The liquid crystal device 400 further comprises a primer layer 430 deposited over the substrate 410. The substrate 410 can be referred to as a “bare” substrate when the primer layer is deposited on it. An alignment layer 420 including a molecular crystalline material is formed from a lyotropic liquid crystal material deposited over the primer layer 430. The primer layer 430 improves adhesion of the alignment layer 420 to the substrate 410. This structure of the liquid crystal device 400 is effective for non-planar substrates, such as TFT substrates having a TFT array or transflective LCD substrates having reflective structures in addition to a TFT array. The liquid crystal device 400 further comprises a liquid crystal layer 440 deposited over the alignment layer 420.

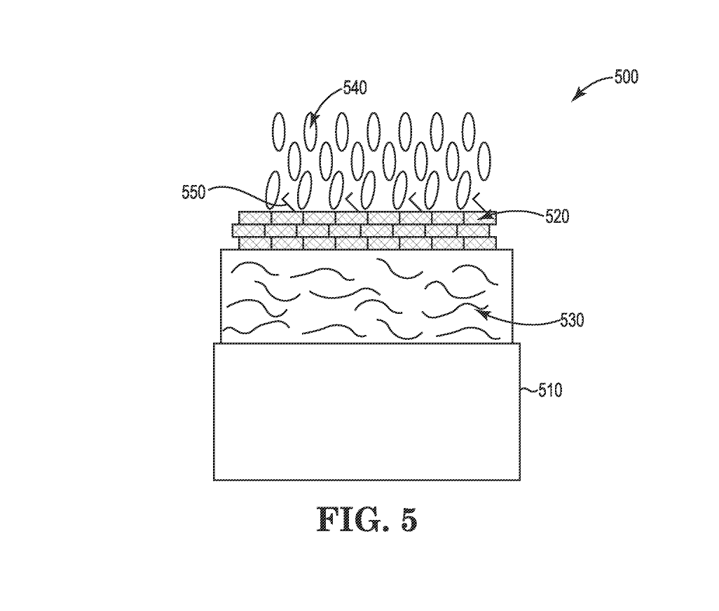

A modification of the liquid crystal device 400 is shown on FIG. 5. FIG. 5 is a partial view of a liquid crystal device 500 with homeotropic liquid crystal molecular alignment obtained by combining the primer layer 530 and the alignment layer 520. The liquid crystal device 500 comprises a substrate 510 and a primer layer 530 deposited over the substrate 510. An alignment layer 520 including a molecular crystalline material is formed from a lyotropic liquid crystal material deposited over the primer layer 530. The primer layer 530 improves adhesion of the alignment layer 520 to the substrate 510. The top surface the alignment layer 520 is modified with a surface modification agent or surfactant 550. The liquid crystal device 500 further comprises a liquid crystal layer 540 deposited over the surface modification agent or surfactant 550. The liquid crystal layer 540 is preferably a thermotropic liquid crystal layer.

In general there are two physical mechanisms of liquid crystal alignment in the presence of the alignment layer. The first one, short range, is steric interaction amongst nematic liquid crystal molecules. A characteristic length scale of such interaction is several hundred nanometers. The second one, to be long-range in conventional technology, is the interaction of the liquid crystal molecules with the alignment layer. A characteristic length scale of this aligning interaction is defined by the period of modulation of the alignment layer surface conditions. In case of mechanical rubbing it is about 100 micrometers and there is a gap between the short-range and long-range ordering. Photo-alignment, which uses UV light exposure, can modulate surface conditions of the alignment layer on 200-300 nm scale.

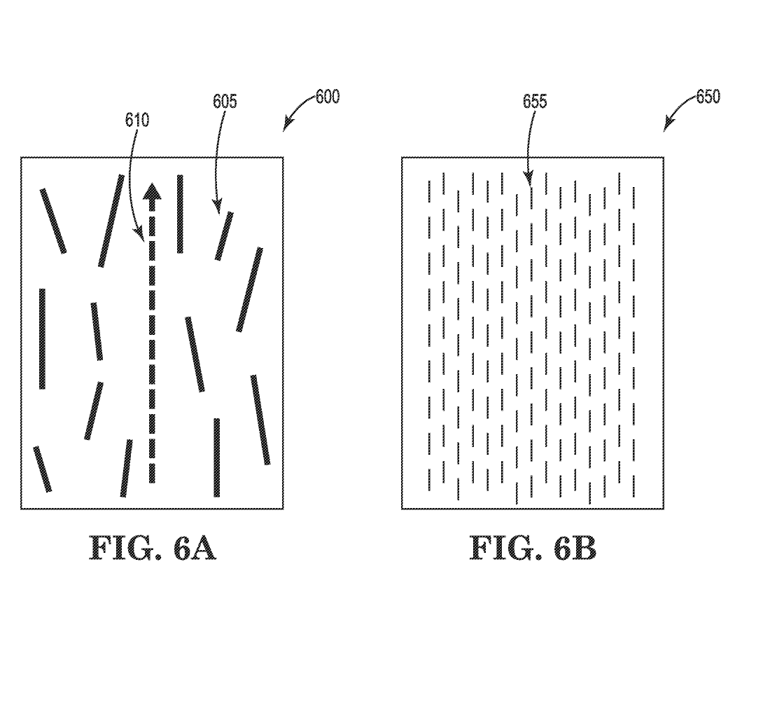

In case of the alignment layer described in the present disclosure this characteristic length scale is reduced down to nm scale and the gap is eliminated. This comparison between currently used mechanically rubbed alignment layers and alignment layers described in the present disclosure is illustrated in FIG. 6A and FIG. 6B.

FIG. 6A is a schematic illustration of a surface anchoring interaction on a surface of a conventional liquid crystal alignment layer 600 obtained by mechanical rubbing, while FIG. 6B is a schematic illustration of a surface anchoring interaction on a surface of a liquid crystal molecular alignment layer 650, according to an example embodiment. In conventional alignment layer in FIG. 6A, 20 micrometers rubbing pile is much larger in size than thermotropic liquid crystal molecules. Local variation in rubbing direction creates variation in liquid crystal molecular alignment directions 605. However, in spite of local variation in alignment directions 605, the alignment directions averaged over a large area is still substantially along a single direction 610.

When pixel sizes are greater than 100 μm, the liquid crystal molecular alignment direction in each pixel will be sufficiently uniaxial in the conventional alignment technology. On the other hand, when the pixel size is reduced to ˜70 μm or smaller, variation in surface alignment direction in each pixel becomes more important. Each pixel has a slightly different direction of molecular alignment, resulting in lower contrast ratios and slower optical response times due to different alignment directions in the neighboring pixels. When an external electric field is applied to the liquid crystal panel, there is some conflict among liquid crystal molecules in their movement directions at the boundaries between adjacent pixels due to the slightly different molecular alignment directions.

On the other hand, the intrinsic ordering of the anchoring layer 650 shown in FIG. 6B provides uniform uniaxial alignment direction 655 in accordance with the current disclosure. Each molecule of the liquid crystal is under the action of the aligning force that results in uniform uniaxial liquid crystal alignment with no steric conflict at pixel boundaries. Since the alignment layer 650 orients the liquid crystal on molecular level it can be patterned.

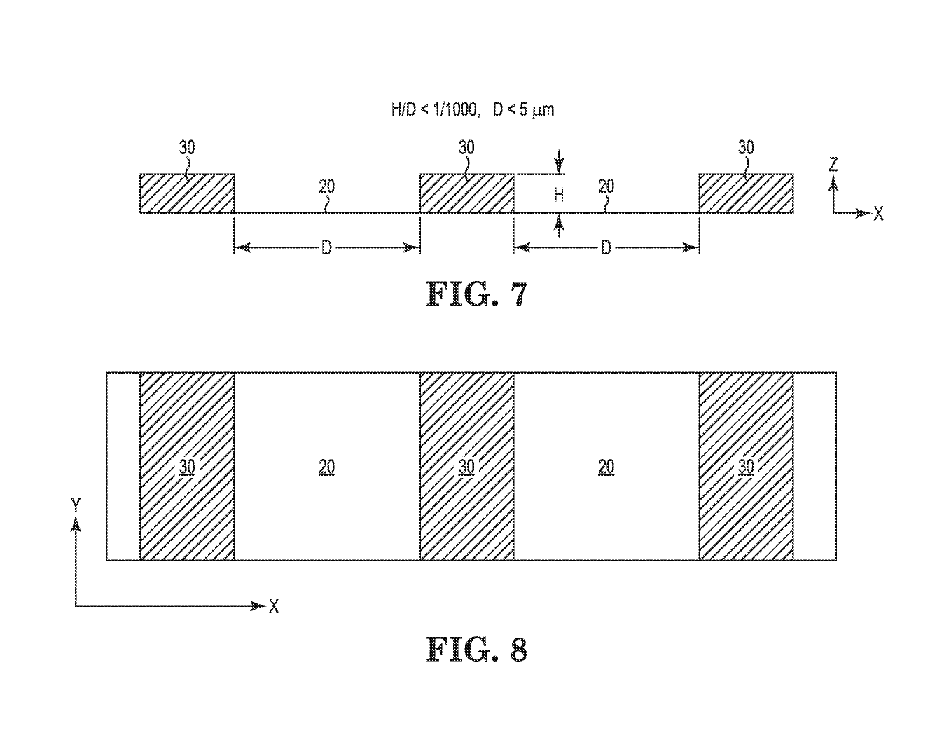

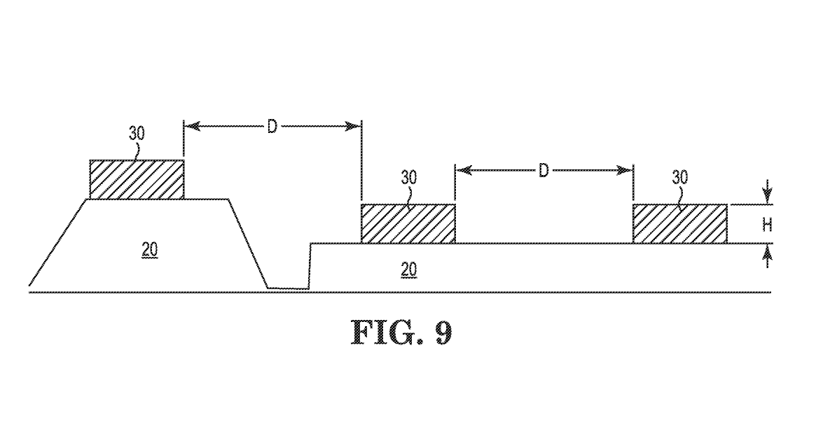

FIG. 7 is a schematic partial cross-sectional view of such a molecular alignment layer. In this case we refer to a group of discrete molecular crystalline structures 30 that are isolated from each other as an alignment layer on a substrate 20. FIG. 8 gives a schematic top view of the discrete molecular crystalline structures 30 on a substrate 20 of FIG. 7 that are collectively referred to as the molecules alignment layer. FIG. 9 is a schematic partial cross-sectional view of an exemplary thin film transistor (TFT) in a liquid crystal device with groups of discrete molecular crystalline structures 30 that are isolated from each other as an alignment layer on a substrate 20. FIG. 9 illustrates that the substrate topography may not be planar.

Isolated structures in FIG. 7 and FIG. 8 provide the liquid crystal with anchoring and local alignment (highly ordered as shown in FIG. 6B within the features 30) which is translated over the areas or substrate 20 due to steric interactions. The distance between the features is up to ten micrometers, and more preferably up to five micrometers. In addition to having these discrete features extend in two dimensions over the substrate, it is preferable that the height of the features (H) be much smaller than the distance between adjacent features (D), such as the ratio H/D is less than 1/500. More preferably the ratio is 1/1000. Even if the substrate has a surface topography, like TFT matrix and/or color filter arrays (FIG. 9) this H/D preferred ratio substantially promotes uniform alignment of the liquid crystal.

### EXAMPLES

### Example 1

### Permittivity Measurement

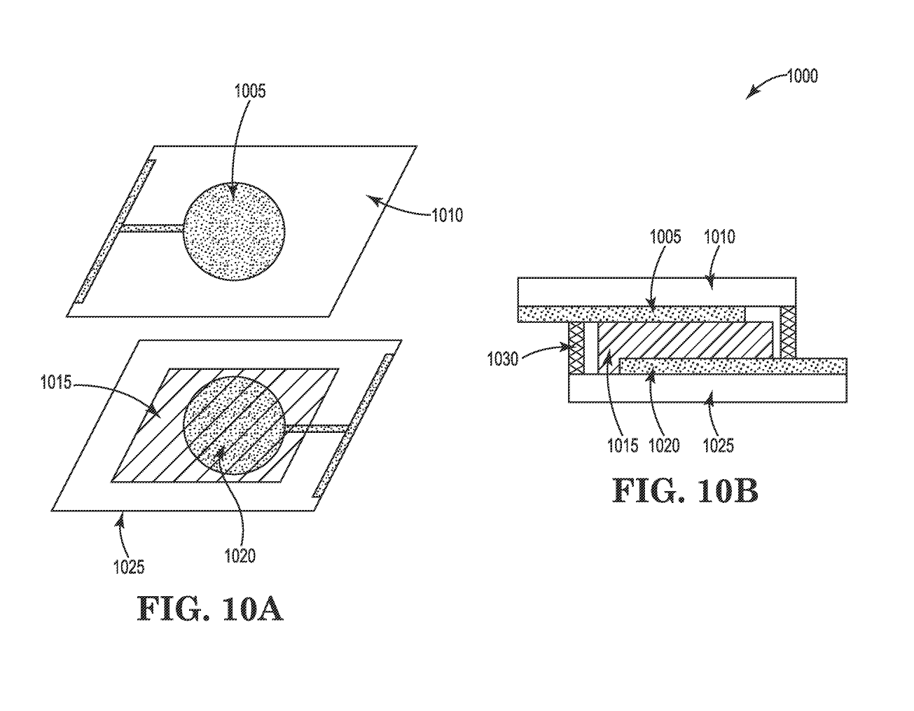

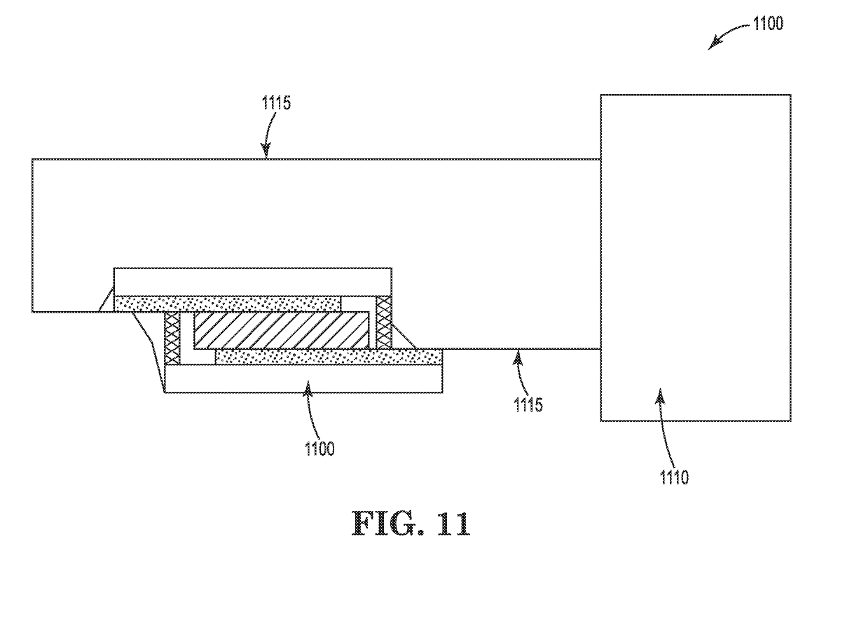

FIG. 10A shows a schematic diagram perspective exploded view of a panel 1000 for a permittivity measurement of the liquid crystal alignment layer. FIG. 10B shows a schematic diagram cross-sectional view of a sample panel 1000 for a permittivity measurement. The experimental set-up for the permittivity measurement is shown schematically in FIG. 11. An alignment layer 1015 comprising one of the materials presented by Structures I-VI was coated with the use of the Mayer rod on a substrate having a 600 Å-thick In₂O₃ transparent electrode 1020 of a 20 mm-diameter circular shape on a 1.1 mm-thick silicate glass substrate 1025. The thickness of the coated alignment layer 1015 was measured by a multiple reflection fringe method widely used for thickness measurements of optical media. A counter-electrode substrate having a 600 Å-thick In₂O₃ transparent electrode 1005 on a glass substrate 1010 was laminated on the alignment layer coated glass substrate 1025 using a UV curable adhesive 1030 in a peripheral area. The laminated panel was then packed in a vacuum bag (not shown).

FIG. 11 schematically shows a permittivity measurement set-up 1100. The permittivity of the vacuum bagged laminated panel 1100 was measured using an electrically connected 1115 LCR meter 1110 (inductance (L), capacitance (C), and resistance (R) meter) (Agilent Model 4294A) with 1 kHz, Vₚ₋ₚ=1 V probe voltage as shown in FIG. 11.

### Example 2

### Liquid Crystal Device: Hand Coated Alignment Layer

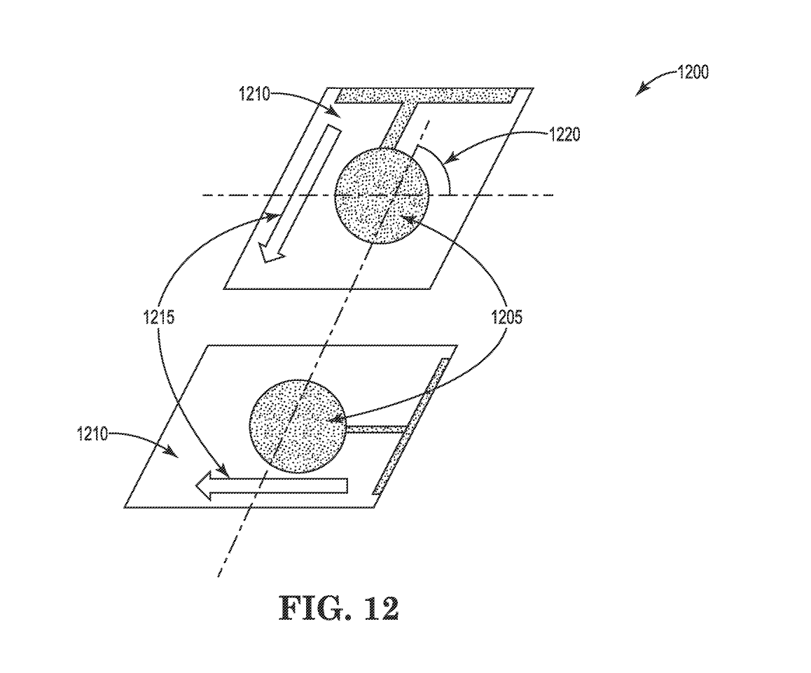

FIG. 12 shows a schematic diagram perspective exploded view of a sample panel 1200 for a twisted nematic liquid crystal panel, according to an example embodiment. Silicate glass substrates 1210 of 25 mm (length)×30 mm (width)×1.1 mm (thickness), having 600 Å thick In₂O₃ transparent round electrodes 1205 of 20 mm diameter, sheet resistance 15 Ω/square were used. These substrates were cleaned using high alkaline detergent: Semico Clean 56 (Furuuchi Chemical). The substrates were sonicated at 40 kHz, 80 W for 10 minutes in the Semico Clean 56 of the original concentration. After ultrasonic cleaning, the substrates were rinsed with deionized water (DI) water for 2 minutes with a rinsing machine of continuous cascade type. Then the substrates were dried by compressed nitrogen and placed to a clean oven set to 110° C. Then alignment layer material was deposited on the clean substrates with the coating direction 1215 indicated by the arrows.

Coating liquid comprising 12% solution of the compounds presented by Structures I and II taken in 80:20 ratio was coated on the prepared substrates using the Mayer Rods. Two pairs of electrode substrates were coated using MR#2.0 and MR#2.5, respectively. The coated substrates were dried with compressed nitrogen until the anisotropic film was formed on the substrate. Thickness of the coatings was measured by a profilometer Dektak 3ST and found to be 0.20 and 0.30 μm, respectively.

Then spacer particles were applied using spin coating method with 0.05 wt % concentration of the particles dispersed in isopropyl alcohol (IPA). Spin coating condition was set as 15 seconds at 200 rpm, then 35 seconds at 1,200 rpm, under dry nitrogen atmosphere. Substrates with deposited spacers were dried at 85° C., for 10 minutes on a hot plate. Then the substrates with the same coating thicknesses were laminated using photo-curable glue seal (Norland 65:Norland) with an angle of 87 degrees 1220 between the first (or top) substrate and the second (or bottom) substrate as shown in FIG. 12. This configuration corresponds to the twisted nematic (TN) mode. Then the panels were placed into vacuum bags, evacuated by the vacuum sealer, and UV cured (365 nm, 3,000 mJ). Afterwards, the vacuum bag was kept in 60° C. oven for 3 hours. Then, the bags were opened and the cells were filled with the nematic liquid crystal mixture (MDA-12-1518 Merck) at its isotropic temperature of 105° C. by capillary effect.

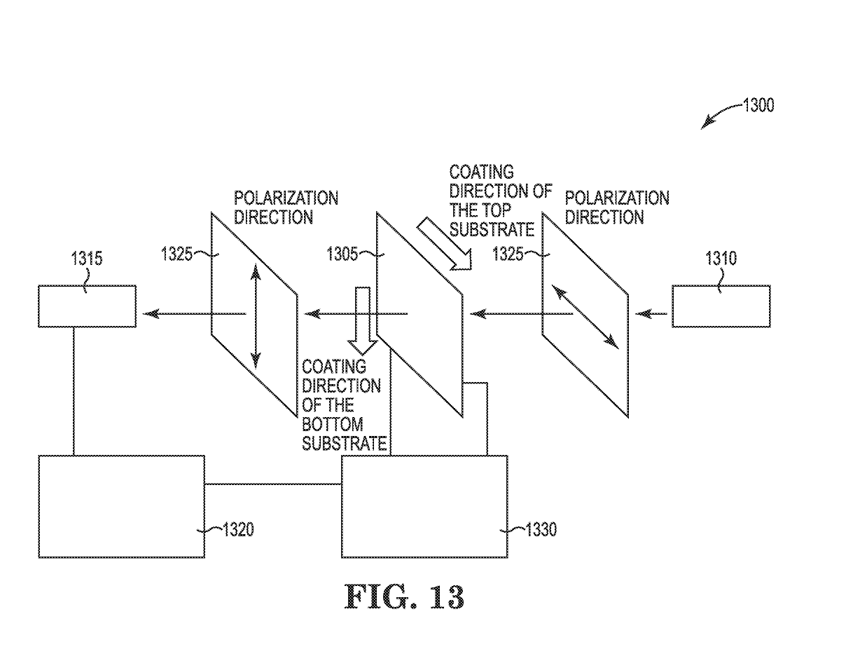

Using the above prepared twisted nematic panel, the electro-optical response times and threshold voltage were measured. FIG. 13 illustrates the measurement setup. A He—Ne laser 1310 beam (633 nm wavelength, 1 mm diameter, horizontal linear polarization) was used as a light source. The panel under test 1305 was placed between two crossed polarizers 1325. Photodetection system comprised a photo-multiplier 1315 (Hamamatsu H7422-20). The photo-multiplier output was connected to a digital oscilloscope 1320 as illustrated in FIG. 13. The panel is driven by a power supply 1330. “On” and “Off” times were measured between 10% and 90% light intensity levels; threshold voltage was measured at 10% transmittance.

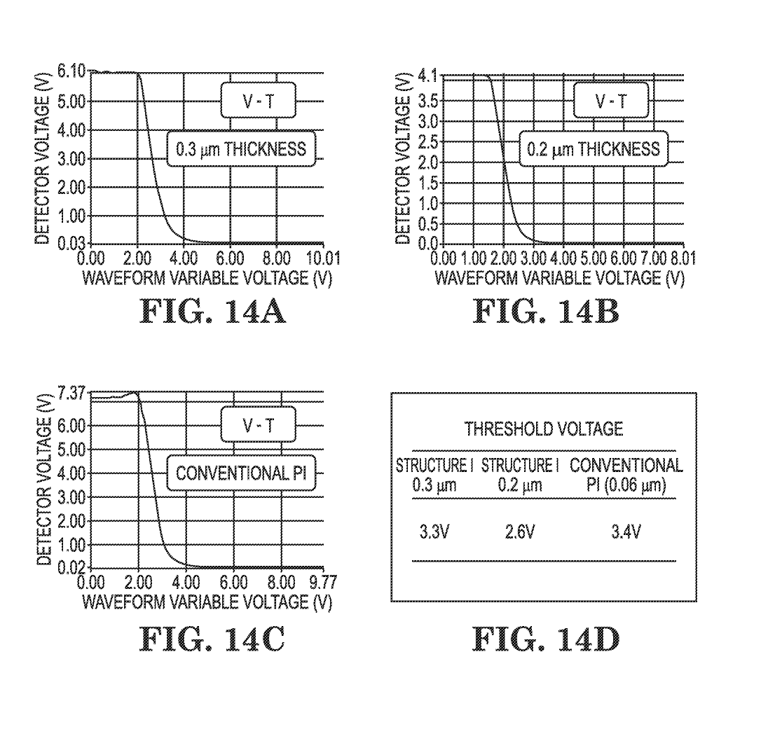

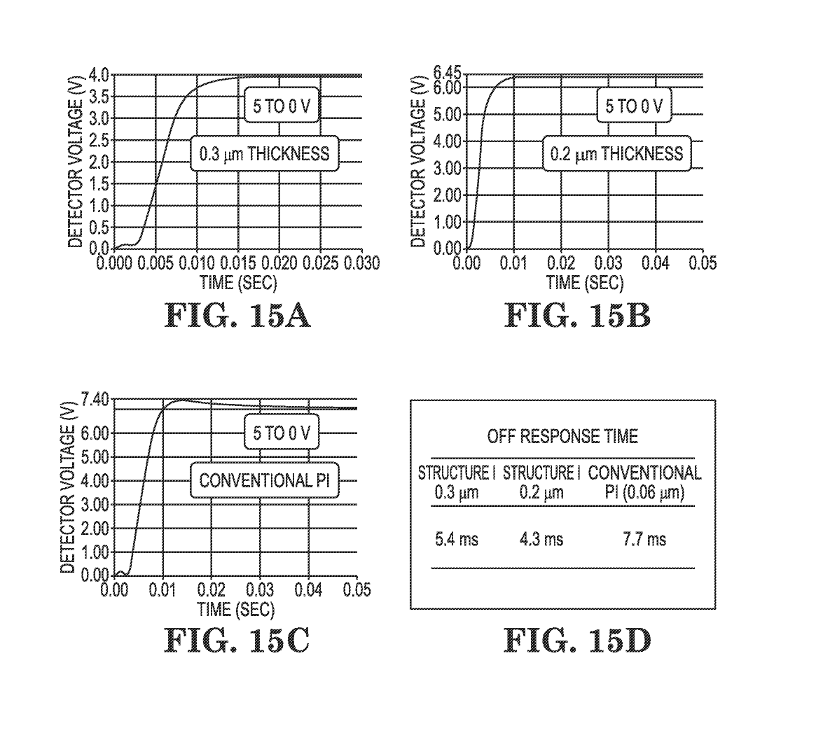

FIG. 14A-14D and FIG. 15A-15D summarize electro-optical response (threshold voltages and off times) of the prepared panels with 0.3 micrometer thick alignment layer, 0.2 micrometer thick alignment layer, and conventional polyimide (PI) layer, respectively. The preparation of the sample using a conventional PI layer is explained below in Example 3. It can be seen that the panel having alignment layers deposited from lyotropic liquid crystal materials demonstrate both faster optical response times and lower threshold voltages compared to the control sample having standard rubbed PI alignment layer.

### Example 3

### Liquid Crystal Device: Control

Electrodes were prepared as described in the Example 2. Polyimide material SE-3510S (Nissan Chemical) of 1.5 wt % solids content was used. The polyimide precursor solution was formed as a 600 Å thickness layer by spin coating at 300 rpm, 15 seconds, followed by 2,500 rpm, 50 seconds. After spin coating, the substrates were dried on a hot plate set to 80° C. for 5 minutes. Then, the substrates were placed to a clean oven at 250° C. for 1 hour for curing. After that the surface of the cured polyimide was rubbed using a custom made rubbing machine under the following conditions: 2″ diameter rubbing cylinder, contact length 0.3 mm, three passes at 500 rpm and 5 mm/s stage speed. After the rubbing, a pair of substrates was laminated at 87 degrees in accordance with FIG. 12. The cell was filled with the nematic liquid crystal mixture (MDA-12-1518 Merck) at its isotropic temperature of 105° C. by capillary effect.

### Example 4

### Liquid Crystal Device: Flexoprinted Alignment Layer

Electrodes were prepared in accordance with the procedure described in the Example 2.

Coating liquid comprising 12% solution of the compounds presented by Structures I and II taken in 80:20 ratio was deposited on the prepared substrates with the use of the flexoprinting machine (Nihon Denshi Seiki Co., Ltd.). The printing pressure was varied for different pairs of electrodes from 0.02 to 0.15 mm gap between Anilox roll and the glass substrate. The printed material was further dried with compressed air until the anisotropic coating was formed on the substrate. For all cases the thickness of the coating was less than 0.08 μm based on multiple reflection observation.

A TN cell was assembled as explained in the Example 2 and filled with the nematic liquid crystal mixture (MDA-12-1518 Merck) at its isotropic temperature of 105° C. by capillary effect.

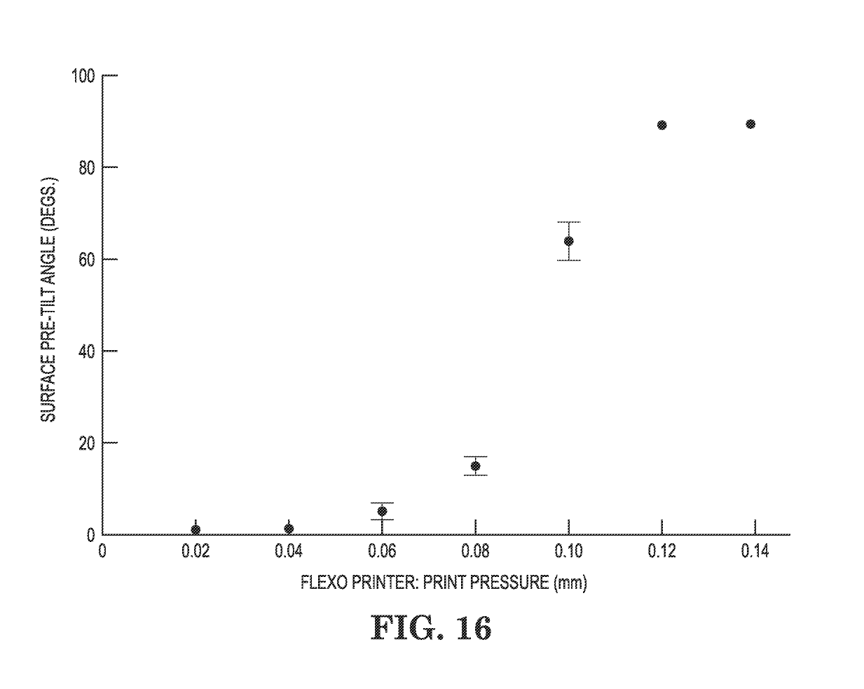

Experimental dependence of the liquid crystal pre-tilt angle is presented in FIG. 16.

Samples having alignment layers printed with the pressures of 0.02-0.08 mm demonstrated planar liquid crystal alignment. As assembled they demonstrated the bright state with no voltage applied, and the black state with over-threshold voltage (over 4 V). Electro-optical response times and threshold voltage are in correspondence with the data presented in the Example 2.

Samples having alignment layers printed with the pressures of 0.10-0.15 mm demonstrated mostly homeotropic alignment with dark state in crossed polarizers. No switching was observed with and without voltage applied.

### Example 6

### Liquid Crystal Device: Flexoprinted Alignment Layer

A 7% solution of a polymer according to the Structure VI (n=200) with A=SO₃H was printed on the In₂O₃ transparent electrode patterned glass substrates prepared in accordance with the procedure described in the Example 4. Printing pressure set to 0.09 and 0.12 mm gap between Anilox roll and the glass substrate.

Cell assembling and filling was performed as described in the Example 4.

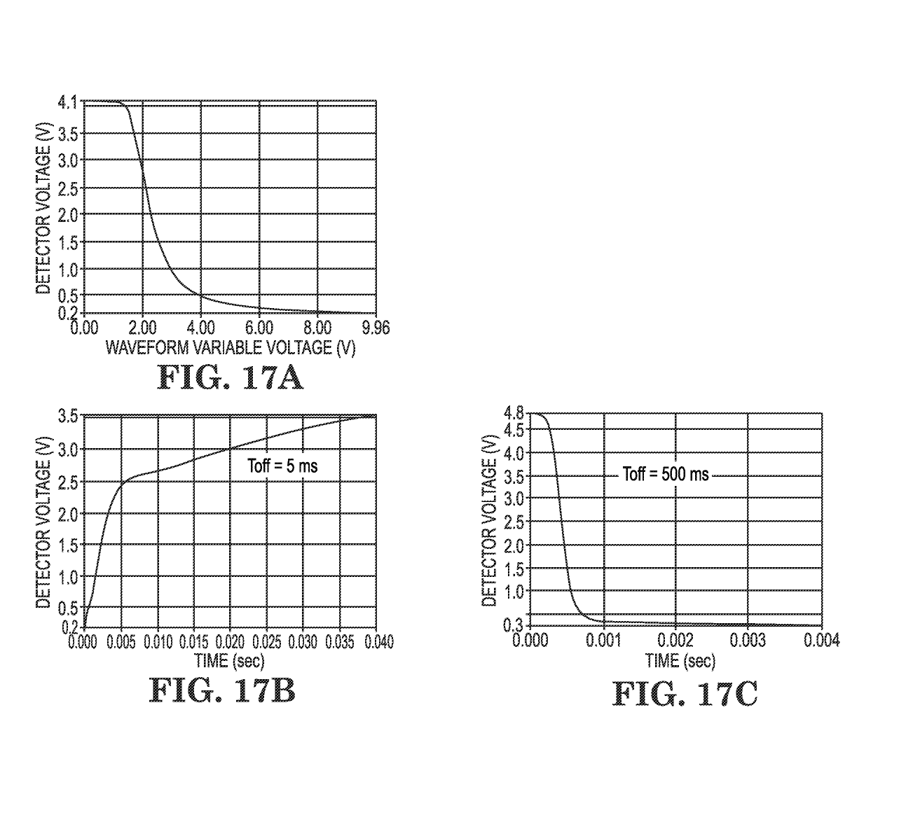

Electro-optical response data measured as explained in the Example 2 is presented in FIG. 17A-17C. Cells comprising the alignment layer deposited with the use of self-assembling polymeric material demonstrate the same performance as shown in the Example 2.

### Example 7

### Smectic Liquid Crystal Device

Substrates were prepared as explained in the Example 2.

Coating liquid comprising 9% solution of the compounds presented by Structures I and II taken in 80:20 ratio was coated with a custom doctor blade (10 cm wide) on the prepared In₂O₃ transparent electrode patterned glass. Coated substrates were dried on the hot plate preheated to 80° C. for 10 minutes.

A pair of above layered substrates was laminated using 2.2 μm diameter size of silicon dioxide particles as spacers. The spacers were applied as described in Example 2. The cell lamination was performed in parallel configuration in the way described in Example 2.

The laminated panel was filled with chiral smectic C phase mixture (Merck ZLI-4851-100) using capillary effect at 120° C. Using multiple reflection method the panel gap was measured to be 3.1 μm.

As disclosed in US 2004/0196428, a unique chiral smectic C phase liquid crystal molecular alignment known as polarization shielded smectic (PSS)-LCD had been confirmed using a rubbed polyimide film on a glass substrate as the alignment layer. Unlike the usual chiral smectic C phase liquid crystal molecular alignment, in a PSS-LCD panel, the initial liquid crystal molecular alignment position does not show any tilt angle from the set azimuthal anchoring direction as shown in FIG. 6A and FIG. 6B. In the Example 7 panel, the initial liquid crystal molecular alignment direction was confirmed under crossed Nicols using a polarized microscope. The presence of the predominant alignment indicates strong azimuthal anchoring energy, as otherwise chiral smectic C phase liquid crystal molecules tend to misalign due high steric demand of the liquid crystal molecules. Therefore, the prepared sample panel of Example7 satisfies the definition of the PSS-LCD initial liquid crystal molecular alignment configuration. Moreover, the measured cell gap of 3.1 micrometer is bigger than the cell gap of less than 2.3 micrometer needed for the PSS-LCD drive mode, which suggests a much stronger azimuthal anchoring energy compared to that of mechanical rubbing of polyimide surface.

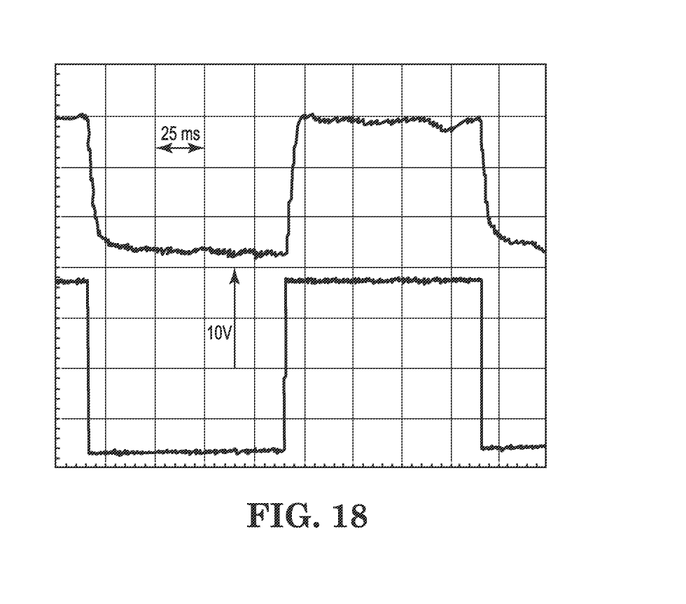

FIG. 18 shows both rise and fall times measured as described in the Example 2. In spite of very large panel gap for a smectic liquid crystal device the rise and fall times are about 2 ms.

### CONCLUSION

Thus, various liquid crystal devices and methods for forming liquid crystal devices have been disclosed. Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses disclosed herein. Accordingly, the present embodiments are to be considered as illustrative and not restrictive.

Thus, embodiments of LIQUID CRYSTAL ARTICLE AND FABRICATION THEREOF are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

1. An article comprising:
a first substrate and second substrate;
a molecular alignment layer having a thickness in a range from 30 to 100 nanometers and comprising a molecular crystalline material formed from lyotropic liquid crystal material and in contact with the first substrate; and
a thermotropic liquid crystal layer comprising thermotropic liquid crystal molecules disposed between the first substrate and second substrate and in contact with the molecular alignment layer.

2. (canceled)

3. (canceled)

4. The article according to claim 1, further comprising a surface energy modification agent between the molecular alignment layer and the thermotropic liquid crystal layer.

5. The article according to claim 4, wherein the surface modification agent comprises a surfactant.

6. The article according to claim 1, wherein the substrate further comprises a primer layer in contact with the molecular alignment layer.

7. The article according to claim 1, wherein the molecular alignment layer comprises a compound or salt of:

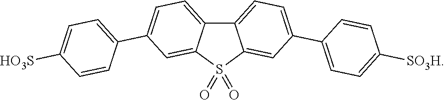 [SMILES: O=S(=O)(O)c1ccc(-c2ccc3c(c2)S(=O)(=O)c2cc(-c4ccc(S(=O)(=O)O)cc4)ccc2-3)cc1]

8. The article according to claim 1, wherein the molecular alignment layer comprises a compound or salt of:

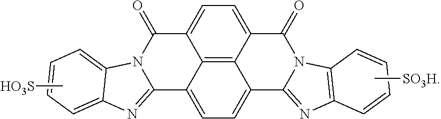

9. The article according to claim 1, wherein the molecular alignment layer comprises a compound or salt of:

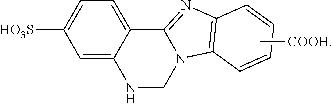

10. The article according to claim 1, wherein the molecular alignment layer comprises a compound or salt of:

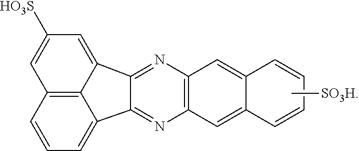

11. The article according to claim 1, wherein the molecular alignment layer comprises a compound or salt comprising: 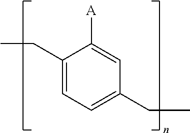
wherein, A is SO₃H or COOH and n is an integer from 5 to 10,000.

12. The article according to claim 1, wherein the molecular alignment layer comprises a compound or salt comprising: 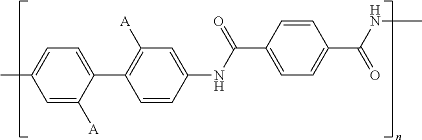
wherein, A is SO₃H or COOH and n is an integer from 5 to 10,000.

13. The article according to claim 1, wherein the molecular alignment layer forms discrete structures that are isolated from each other on the substrate.

14. The article according to claim 13, wherein the discrete structures are separated from adjacent discrete structures by a first distance value and have a first height value from a surface of the substrate and the first distance value is less than 10 micrometers and greater than 500 times the first height value.

15. An optical component comprising:
a substrate;
a molecular alignment layer having a thickness in a range from 30 to 100 nanometers and comprising a molecular crystalline material formed from lyotropic liquid crystal material and in contact with the substrate; and
wherein the alignment layer is capable of aligning a thermotropic liquid crystal layer when the thermotropic liquid crystal layer is in contact therewith.

16. A method for forming an alignment layer, the method comprising:
providing a substrate;
shear coating a lyotropic liquid crystal material on the substrate to form an alignment layer having a thickness in a range from 30 to 100 nanometers and;
wherein the alignment layer is capable of aligning a thermotropic liquid crystal layer when the thermotropic liquid crystal layer is in contact therewith.

17. The method according to claim 16, wherein the shear coating step comprises printing the lyotropic liquid crystal material on the substrate to form an alignment layer.

18. The method according to claim 16, wherein the shear coating step comprises printing discrete structures formed of lyotropic liquid crystal material, the discrete structures being isolated from each other on the substrate and forming an alignment layer.

19. The method according to claim 16, wherein the step of providing a substrate further comprises depositing a primer layer on a bare substrate to form the substrate.

20. The method according to claim 16, further comprising depositing a surface modification agent on the molecular alignment layer.

21. The method according to claim 16, further comprising depositing a thermotropic liquid crystal layer on the alignment layer to form an optical component.

22. The method according to claim 21, further comprising assembling a second substrate on the thermotropic liquid crystal layer to form a liquid crystal device.
